(19) United States
(12) Patent Application Publication
(10) Pub. No.: US 2026/0188550 A1
(43) Pub. Date: Jul. 2, 2026

(54) REINFORCED MAGNETIC SHEET AND MANUFACTURING METHOD THEREOF

(71) Applicant: HANGZHOU ASWEETS CULTURAL CREATIVE CO.,LTD, HANGZHOU (CN)

(72) Inventor: Fujian Zhao, SHAOXING (CN)

(21) Appl. No.: 19/013,083

(22) Filed: Jan. 8, 2025

(30) Foreign Application Priority Data
Dec. 27, 2024 (CN) 202411944721.8

(51) Int. Cl. H01F 7/02; A63H 33/04; H01F 41/02

(52) U.S. Cl. CPC H01F 7/02; H01F 41/0266; A63H 33/046

(57) ABSTRACT

A reinforced magnetic sheet and a manufacturing method thereof are provided, the reinforced magnetic sheet includes two cover plates and a magnet. The two cover plates are provided with an inner cavity and are fixedly connected. The magnet is provided in the inner cavity, one end of the magnet is N pole, and the other end of the magnet is S pole, so that the two cover plates have magnetic. The inner sides of the two cover plates are provided with a reinforcement member, which is arranged in the inner cavity. The present disclosure solves a technical problem of large magnetic sheets being prone to breakage.

### CROSS-REFERENCE TO RELATED APPLICATIONS

This application claims priority to Chinese Patent Application No. 202411944721.8, filed on Dec. 27, 2024, which is hereby incorporated by reference in its entirety.

### TECHNICAL FIELD

The present disclosure relates to the field of toy technologies, and in particular, to a reinforced magnetic sheet and a manufacturing method thereof.

### BACKGROUND

In recent years, with a continuous improvement of people's living standards, a demand for life quality has become increasingly high, and the cultivation of children has also become more and more important. Most families prioritize the intellectual development of young children. For the development of children's intelligence, the market has various types of puzzle toys, such as magnetic sheet toys.

Magnetic sheet toys are made by assembling various magnetic sheets into different shapes. Children can use their potential imagination to assemble their favorite models according to shapes of different magnetic sheets. However, most of the current magnetic sheets are small, with a size of 5-20 cm or less. These magnetic sheets are suitable for young children to play with and cannot be built.

In toy houses or other designs for internal activities, it is usually necessary to design large magnetic sheets of 20-90 cm. However, if these magnetic sheets are not structurally reinforced, they are prone to breakage.

### SUMMARY

The purpose of the present disclosure is to solve the above-mentioned technical problems in the prior art, provide a reinforced magnetic sheet and a manufacturing method thereof, and solve the technical problem of large magnetic sheets being prone to breakage.

In order to solve the above technical problems, the present disclosure adopts the following technical solution.

A reinforced magnetic sheet, including two cover plates and a magnet; the two cover plates are provided with an inner cavity and the two cover plates are fixedly connected; the magnet is provided in the inner cavity, one end of the magnet is N pole and the other end of the magnet is S pole so that the cover plates have magnetic; the reinforced magnetic sheet further includes a reinforcement member, which is provided in the inner cavity and fixed on inner sides of the cover plates.

In some embodiments of the present disclosure, each of two cover plates includes an end face and a connection face, there is a gap between end faces of the two cover plates; connection faces of the two cover plates are spliced together, so that the two cover plates are connected in a sealed manner.

In some embodiments of the present disclosure, the reinforcement member includes first reinforcement ribs, the first reinforcement ribs are fixed to the end faces, and the first reinforcement ribs are fixed to the connection faces.

In some embodiments of the present disclosure, the reinforcement member includes second reinforcement ribs, the second reinforcement ribs are fixed to the end faces, and the second reinforcement ribs are fixed to the first reinforcement ribs.

In some embodiments of the present disclosure, inner sides of the cover plates are provided with first connection columns, the first connection columns of the two cover plates are inserted into each other; the inner sides of the cover plates and the first connection columns are provided with third reinforcement ribs.

In some embodiments of the present disclosure, a connection between the two cover plates is fixed by ultrasonic welding.

In some embodiments of the present disclosure, the cover plates are provided with a through hole, and a plate body is provided between the two cover plates; the plate body is provided corresponding to the through hole so that customized information on the plate body is provided in the through hole.

In some embodiments of the present disclosure, the inner sides of the cover plates are provided with an installation part, and the installation part is fixed to the plate body.

In some embodiments of the present disclosure, the installation part includes second connection columns, and the second connection columns of the two cover plates are inserted into each other; the plate body is provided with an installation hole, and the second connection columns pass through the installation hole; the inner sides of the cover plates and the second connection columns are provided with fourth reinforcement ribs.

In some embodiments of the present disclosure, the cover plates are provided with a recess, and the recess is recessed towards a direction of the inner cavity.

In some embodiments of the present disclosure, the inner sides of the cover plates are provided with an installation frame, and the installation frame is provided with an installation groove, the installation groove is configured to install the magnet, and an inner side of the installation groove is provided with fifth reinforcement ribs.

In some embodiments of the present disclosure, the inner sides of the cover plates are provided with a light-emitting element, the cover plates are transparent cover plates, and light from the light-emitting element is capable of passing through the cover plates.

In some embodiments of the present disclosure, a battery is provided on the inner sides of the cover plates, and the battery supplies power to the light-emitting element.

A manufacturing method for the reinforced magnetic sheet, including the following steps:
S1: injecting two cover plates into one piece through a mold;
S2: installing a magnet in an inner cavity of the cover plates;
S3: processing a plate body separately, customizing the plate body, and then placing the plate body between the two cover plates;
S4: fixing the two cover plates together by splicing, first connection columns on inner sides of the cover plates are inserted into each other, so that the two cover plates are fixedly connected.

The present disclosure has the following beneficial effects due to the above technical solution. The present disclosure provides a plurality of reinforcement members on inner sides of the cover plates, which increase the strength and rigidity of the cover plates. The strength of the cover plates with reinforcement members is about 15% higher than that without reinforcement members, and a size of the magnetic sheet can be designed to be 20-90 cm, thereby solving a technical problem of large magnetic sheets being prone to breakage.

### BRIEF DESCRIPTION OF DRAWINGS

The present disclosure will be further explained in combination with the accompanying drawings

FIG. 1 is a schematic structural diagram of a first embodiment of the present disclosure.

FIG. 2 is an exploded view of FIG. 1.

FIG. 3 is an enlarged schematic structural diagram at part A in FIG. 2.

FIG. 4 is a schematic structural diagram of a cover plate in the first embodiment of the present disclosure.

FIG. 5 is a schematic structural diagram of installing a light-emitting element on the cover plate in the first embodiment of the present disclosure.

FIG. 6 is a schematic structural diagram of a plate body in the first embodiment of the present disclosure.

FIG. 7 is a schematic structural diagram of a second embodiment of the present disclosure.

FIG. 8 is a schematic structural diagram of a third embodiment of the present disclosure.

Numeral reference: 1 cover plate; 1a end face; 1b connection face; 2a first reinforcement rib; 2b second reinforcement rib; 2c third reinforcement rib; 2d fourth reinforcement rib; 3 first connection column; 4 second connection column; 5 installation frame; 6 installation groove; 7 PC sheet; 8 installation hole; 9 through hole; 10 recess; 11 light strip; 12 fixing groove; 13 battery.

### DESCRIPTION OF EMBODIMENTS

The present disclosure designs a reinforced magnetic sheet with a size of 20-90 cm, which is used in toy houses or other shapes of internal activities.

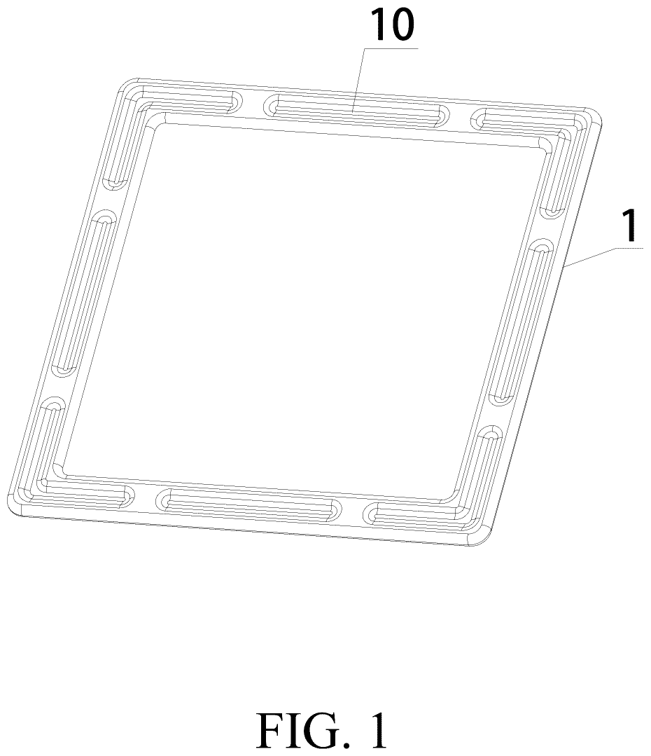

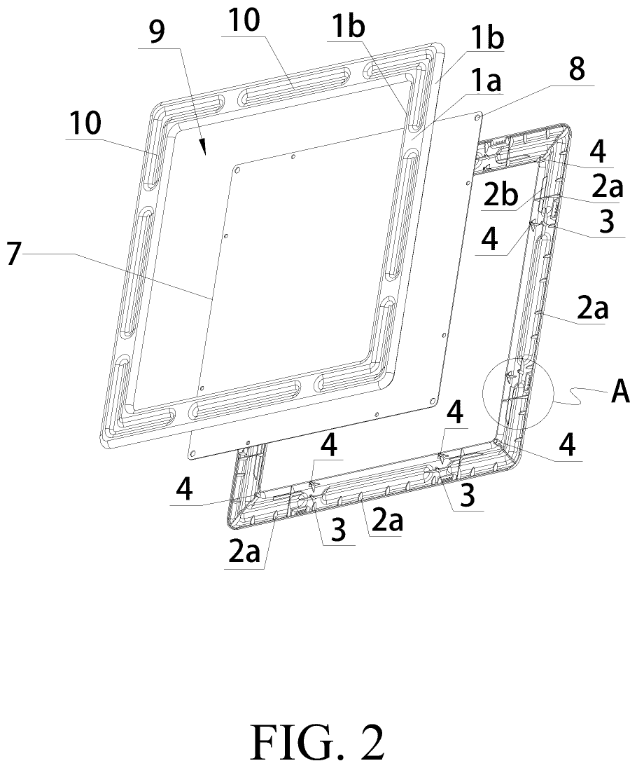

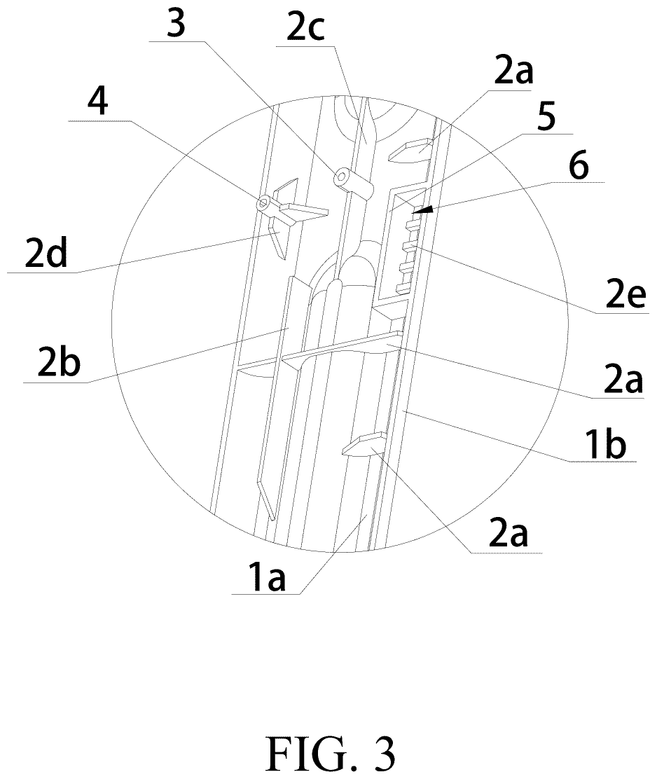

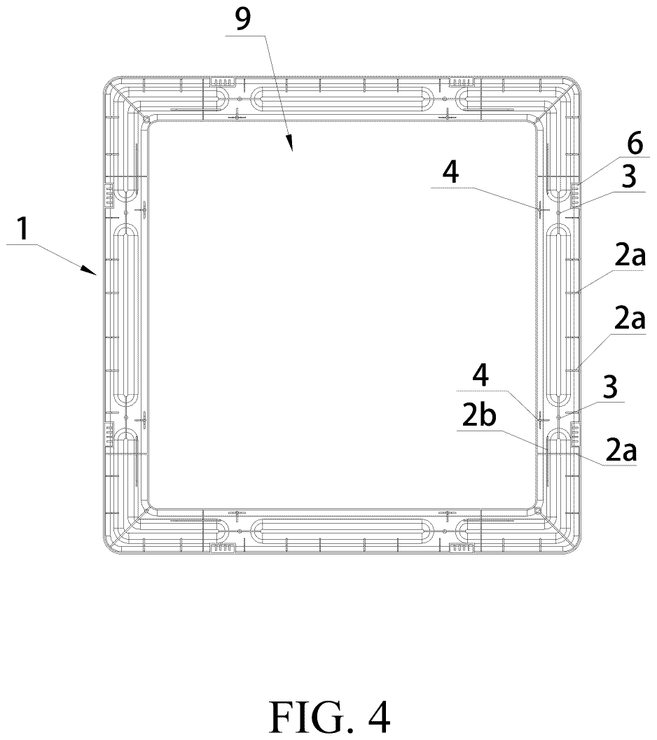

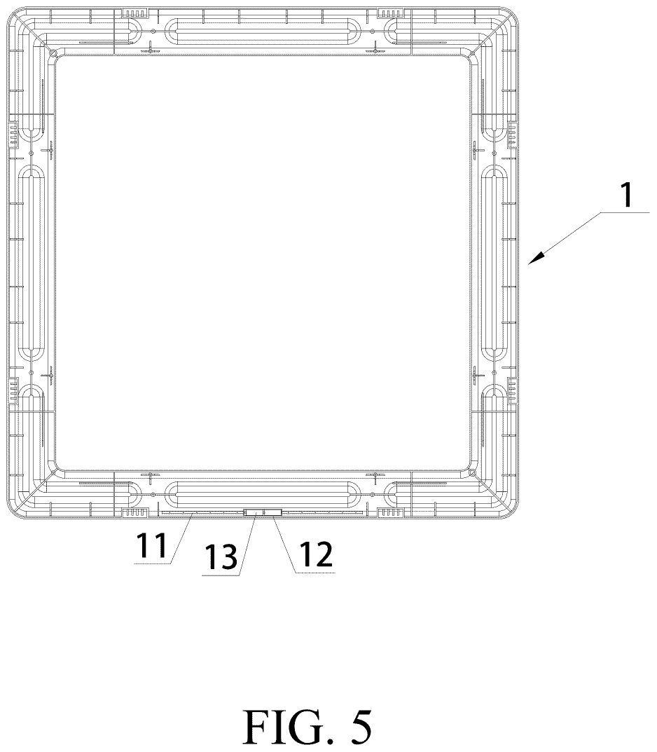

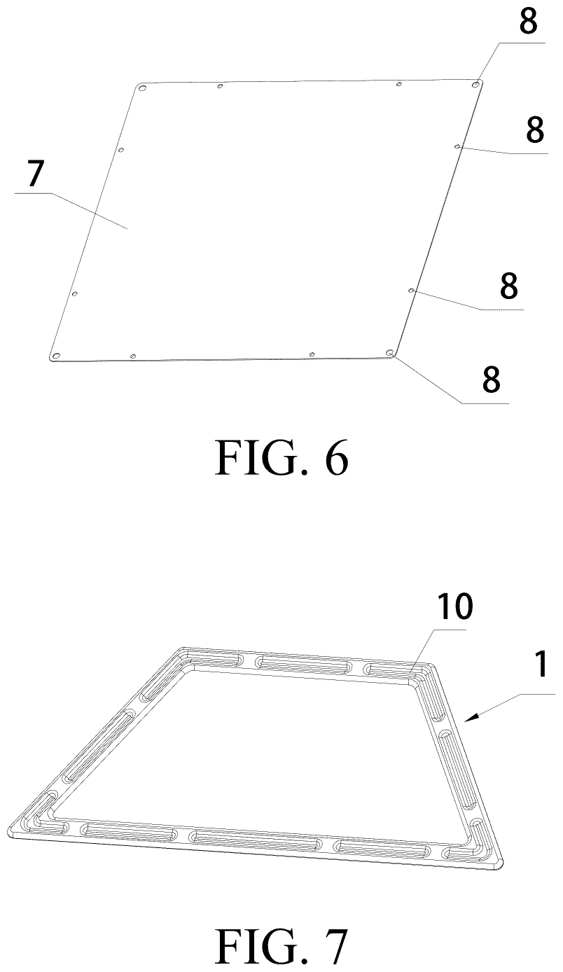

As shown in FIGS. 1 to 6, which is a first embodiment of the present disclosure, the reinforced magnetic sheet includes two cover plates 1 and a magnet. The two cover plates 1 are integrally injection molded through a mold, and the present disclosure provides a plurality of reinforcement members on inner sides of the cover plates 1.

Each of the two cover plates 1 of the present disclosure includes an end face 1a and a connection face 1b. The connection face 1b is configured to be a circular arc shape and is provided at an edge of the end face 1a. The design of the circular arc face can effectively avoid sharp edges of magnetic sheets, thereby reducing the possibility of accidental injury to children during play. This design renders the magnet sheets more suitable for children to use, and parents can also feel more at ease letting their children play and explore. At the same time, the design of the curved face renders the magnetic sheets visually rounded and soft, and an overall appearance more beautiful. This beautiful appearance can attract children's attention, stimulate their curiosity and desire for exploration. Besides that, magnetic sheets with circular arc faces are more flexible in splicing, rendering it easier to construct various shapes and structures. This flexibility helps stimulate children's creativity and imagination, allowing them to learn more knowledge and skills through play. The end face 1a and the connection face 1b form an inner cavity, and there is a certain distance between end faces 1a of two cover plates 1. Connection faces 1b of the two cover plates 1 are spliced together, so that the two cover plates 1 are connected in a sealed manner.

The present disclosure provides a plurality of first reinforcement ribs 2a between the end faces 1a and the connection faces 1b. The first reinforcement ribs 2a are one of the reinforcement members that increase a structural strength of the end faces 1a and the connection faces 1b and can reduce stress concentration between the end faces 1a and the connection faces 1b, thereby avoiding a deformation between the end faces 1a and the connection faces 1b, effectively improving anti-deformation and load-bearing capacity of the magnetic sheets. The first reinforcement ribs 2a of the present disclosure can be fixed to the end faces 1a and one of the connection faces 1b, as well as to the end face 1a and two connection faces 1b.

When the first reinforcement ribs 2a are fixed to the end faces 1a and the two connection faces 1b, the first reinforcement ribs 2a have a certain length. At this time, second reinforcement ribs 2b are provided between the end faces 1a and the first reinforcement ribs 2a, and the second reinforcement ribs 2b and the first reinforcement ribs 2a are arranged in a cross shape. The second reinforcement ribs 2b are one of the reinforcement members. The second reinforcement ribs 2b strengthen the first reinforcement ribs 2a, further increase the structural strength of the end faces 1a and the connection faces 1b and improve the load-bearing capacity of the cover plates 1. Providing the first reinforcement ribs 2a and the second reinforcement ribs 2b can improve the strength and rigidity of the magnetic sheets, increase the stability of the magnetic sheets during use, and render the magnetic sheets better adapt to needs of these complex application scenarios. Besides that, the first reinforcement ribs 2a and second reinforcement ribs 2b can also serve as flow channels during an injection molding process, promoting the filling and uniform distribution of injection materials, and improving the production quality of the magnetic sheets.

Inner sides of the cover plates 1 are provided with a first connection column 3; the number of the first connection column 3 is designed according to sizes of the cover plates 1. The first connection column 3 of one cover plate 1 is provided with a first connection column hole, the first connection column 3 of the other cover plate 1 is inserted into the first connection column hole, so that connection columns 3 of the two cover plates 1 are inserted into each other, thereby connecting the two cover plates 1. The present disclosure is provided with third reinforcement ribs 2c on the inner sides of the cover plates 1 and the first connection columns 3. The third reinforcement ribs 2c are one of the reinforcement members that increase load-bearing capacity of the first connection column 3 and avoid breakage when the first connection column 3 is inserted.

When fixing the two cover plates 1, ultrasonic welding is used at a connection of the connection faces 1b, which has the following technical effects.
(1) Ultrasonic welding technology can complete a welding of one product in an average of only 1.1 to 2.5 seconds, thereby significantly improving the production efficiency, and the ultrasonic welding can achieve the strength of plastic parts themselves, rendering the magnetic sheets more durable and less prone to damage.
(2) The appearance of the magnetic sheets produced by ultrasonic welding technology can maintain consistency, reducing defects caused by uneven welding. At the same time, ultrasonic welding does not require the use of glue or other adhesives, reducing the use of harmful substances and rendering the magnetic sheets safer and more environmentally friendly, suitable for children's use. Moreover, the magnetic sheets are tightly connected through ultrasonic welding technology, rendering them less prone to detachment or breakage, ensuring the integrity and stability of a toy.
(3) The surface of the magnetic sheets welded by ultrasonic waves is smooth and free of burrs, with a comfortable hand feel, suitable for young babies to grip. Moreover, the magnetic sheets are connected by magnetic force, rendering an assembly process easier and simpler, suitable for children to creatively build.
(4) Magnetic sheets can be made of environmentally friendly materials, such as ABS (Acrylonitrile Butadiene Styrene plastic) plastic, which is recyclable and beneficial for resource conservation and environmental protection.

In the present disclosure, a customized plate body is installed between the two cover plates 1. The cover plates 1 are provided with a through hole 9, and the plate body is provided corresponding to the through hole 9. The plate body is a PC (polycarbonate) sheet 7, which has excellent physical and chemical properties, high transparency, high impact strength, and good heat resistance, rendering the PC sheet 7 to be an ideal material for customizing logos. Through a specific technology, logos, patterns, etc. can be customized on the PC sheet 7. A user can see customized information of the PC sheet 7.

The inner sides of the cover plates 1 are provided with an installation part, the installation part includes a second connection column 4. The number of the second connection column 24 is designed according to sizes of the cover plates 1. The second connection column 4 of one cover plate 1 is provided with a second connection column hole, and the second connection column 4 of the other cover plate 1 is inserted into the second connection column hole, so that connection columns 4 of the two cover plates 1 are inserted into each other. The PC sheet 7 is provided with an installation hole 8, and the second connection column 24 passes through the installation hole 8. When the two cover plates 1 are dissembled, the PC sheet 7 can be replaced in a timely manner to meet various customized needs, and the PC sheet 7 can be processed separately. The inner sides of the cover plates 1 and the second connection column 4 are provided with fourth reinforcement ribs 2d. The fourth reinforcement ribs 2d are one of the reinforcement members that increase the load-bearing capacity of the second connection column 4 and avoid breakage when the second connection column 4 is inserted.

The inner sides of the cover plates 1 are provided with an installation frame 5, and the installation frame 5 is provided with an installation groove 6. The magnet is installed in the installation groove 6, in an implementation mode, a shape of the magnet is cylindrical. One end of the magnet is N pole, and the other end of the magnet is S pole, rendering the cover plates 1 have magnetic. When the magnetic sheets are pieced together, they will rotate and cooperate with each other. An inner side of the installation groove 6 is provided with a fifth reinforcement rib, which is one of the reinforcement members that increase the structural strength of the installation groove 6 and meet an embedded installation of the magnet.

The cover plates 1 are transparent cover plates 1, in an implementation mode, they are made of ABS plastic, with the following technical effects.
(1) ABS plastic is a widely used engineering plastic, which is widely used in toy manufacturing due to its excellent impact resistance and chemical stability. It is non-toxic, odorless, does not release harmful substances, and does not pose a threat to children's health. At the same time, corners of the ABS plastic can be processed to be rounded and smooth, avoiding grinding hands and further ensuring the safety of children when using the magnetic sheets.

Moreover, the ABS plastic has high strength and toughness, can withstand large external forces and impact forces, and is not easily damaged. This allows the magnetic sheets to maintain the integrity for a long-time during use, thereby extending the lifespan of the toy.
(2) The ABS plastic has good processing performance and can be used to produce magnetic sheets with a frosted texture. This texture not only renders the magnetic sheets more comfortable to touch, but also enhances the overall texture of the toy.

The ABS plastic magnetic sheets also have advantages in color matching, transparency, and other aspects. High quality ABS plastic magnetic sheets usually have a wide range of color options, and the colors are bright and long-lasting, not easy to fade. At the same time, the ABS plastic has good transparency, which allows the magnetic sheets to present beautiful light and shadow effects under light, increasing the fun and ornamental value of the toy.
(3) The construction of the magnetic sheets is very flexible, which can exercise children's trial and error ability, construction ability, and sense of space. During the process of building magnetic sheets, children need to think about how to splice them together, adjust their angles and positions, which can help improve their spatial cognitive and logical thinking abilities.

Magnetic sheets integrate much knowledge, such as physical magnetic knowledge, force balance relationships, and spatial geometry. Children can unconsciously learn this knowledge while playing, enhancing their scientific literacy and comprehensive abilities.

The inner sides of the cover plates 1 are provided with a light-emitting element, which may be a light strip 11, light from the light strip 11 can pass through the cover plates 1 and provide brightness and has the following technical effects:
(1) Under the illumination of light, a colorful effect can be presented. This effect is particularly pronounced under sunlight or lighting, rendering a model built by the magnetic sheets look like an artwork, full of visual impact.

Moreover, when the magnetic sheets are rotated or moved under light, internal light will also exhibit different colors and brightness with the change of angle, rendering the magnetic sheets more attractive with this dynamic change effect.
(2) A glowing effect of the magnetic sheets provides children with more imaginative space. They can use the magnetic sheets to create various shapes and display different visual effects through the illumination of light, thereby stimulating their creativity and imagination.

The magnetic sheets can also be used as props in light and shadow games. Children can observe the reflection and refraction of light on the magnetic sheets by adjusting its angle and position under sunlight or light, further exploring the mysteries of light and shadow.
(3) The glowing effect of the magnetic sheets renders them suitable for use as indoor decorations. Children can build magnetic sheets into various shapes and place them on bookshelves, windowsills, or headboards, adding a unique artistic atmosphere to the interior.

Moreover, magnetic sheets can also serve as tools for educational enlightenment. By building magnetic sheet models, children can learn basic concepts such as color, shape, and space, while also exploring the mysteries of science by observing the reflection and refraction phenomena of light.

The inner sides of the cover plates 1 are provided with a battery, which supplies power to the light strip 11. The present disclosure can provide a fixing groove 12 on the cover plates 1, the battery 13 is installed in the fixing groove 12, and then a battery compartment cover is provided at the fixing groove 12 for easy replacement of the battery 13; the battery 13 can also be directly fixed to the inner sides of the cover plates 1 using a snap fastener. The installation way of the battery 13 in the present disclosure is not limited to the above two ways, and other fixing ways can be used to fix the battery 13 on the inner sides of the cover plates 1. When installing the battery, follow the positive and negative pole markings to correctly install the battery.

Outer surfaces of the cover plates 1 are provided with a plurality of recesses 10, which are concave towards in a direction of the inner cavity, rendering it convenient for children to grasp and hold the magnetic sheets. Moreover, the design of recesses 10 can also increase the aesthetic appeal of the magnetic sheets.

In the first embodiment, shapes of the cover plates 1 are designed to be square, so that shapes of the magnetic sheets are square.

As shown in FIG. 7, which is a second embodiment of the present disclosure, based on the structure of the first embodiment of the present disclosure, the shapes of the cover plates 1 are changed, and the shapes of the cover plates 1 are designed as trapezoid, so that the shapes of the magnetic sheets are trapezoidal.

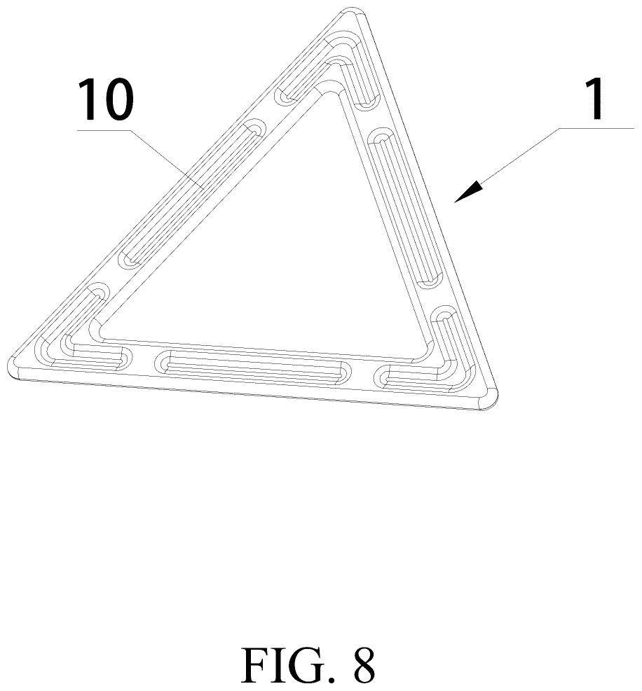

As shown in FIG. 8, which is a third embodiment of the present disclosure, based on the structure of the first embodiment of the present disclosure, the shapes of the cover plates 1 are changed, and the shapes of the cover plates 1 are designed as triangle, so that the shapes of the magnetic sheets are triangle.

Magnetic sheets are creative and educational toys that have various shapes such as triangles, squares, and trapezoids. Chamfers can be set on triangular, square, and trapezoidal magnetic sheets, which can be large or small. The specific dimensions can be designed as follows: the shape of the magnetic sheet is square, with a side length of 420 mm and a thickness of 13 mm. The shape of the magnetic sheet is an equilateral triangle with a side length of 400-405 mm and a thickness of 13 mm. The shape of the magnetic sheet is an isosceles trapezoid, with a bottom length of 820-825 mm, a height of 360-365 mm, and a thickness of 13 mm. The combination of triangle, square, and trapezoidal magnetic sheets; vertices of three types of virtual intersection lines overlapping, which can stimulate players'creativity and imagination, allowing them to discover new construction ways and structures through continuous try and experimentation. At the same time, the construction process of magnetic sheets can exercise players' hands-on ability, spatial imagination, and logical thinking ability, which has a positive impact on children's intellectual development. Moreover, the diversity and variability of magnetic sheets render the construction process enjoyable, and players can experience a sense of achievement and satisfaction during the construction process.

A manufacturing method of the reinforced magnetic sheet includes the following steps:
S1. installing a mold onto an injection molding machine, ensuring that the mold is securely and accurately positioned; injecting molten material into the mold, filling a mold cavity, and injecting cover plates of the present disclosure through the mold, during an injection molding process, controlling a temperature, pressure, and injection speed; after the injection is completed, colling material in the mold naturally to room temperature to solidify; after the material in the mold is completely solidified, opening the mold and removing injection molded cover plates.

The removed cover plates can be subjected to appearance inspection, dimensional measurement, and performance testing to ensure that the cover plates meet design requirements.
S2: installing a magnet in an inner cavity of the cover plates 1, ensuring that position and direction of the magnet are correct.
S3: independently processing a plate body and customizing it, the plate body is made of a PC sheet 7, according to sizes of the cover plates 1, a size of the PC sheet 7 can be set by laser cutting; then, customizing logos, patterns, etc. on the PC sheet 7, and placing the plate body between two cover plates 1.
S4: splicing the two cover plates 1 together, and first connection column 3 on inner sides of the cover plates 1 are inserted into each other, so that the two cover plates 1 are fixedly connected.

Ultrasonic welding can be used to further fix edges of the two cover plates 1, which includes the following steps:
1) starting an ultrasonic welding machine, applying a preset pressure to the edges of the two cover plates 1 under an action of air pressure, by a welding head;
2) converting electrical energy into high-frequency vibration waves, by an ultrasonic generator, and being transmitted to edges of the cover plates 1 through a transducer and the welding head; the welding head vibrates at a frequency of 20000 to 40000 times per second to generate frictional heat;
3) under a combined action of high-frequency vibration and pressure, the edges of cover plates 1 begin to melt and form a molten pool; material in the melt pool forms fusion between molecular layers, thereby achieving a welding between the two cover plates 1;
4) after the welding is completed, turning off the ultrasonic welding machine and colling the material in the molten pool naturally and solidify, obtaining required magnetic sheet, during a cooling process, avoiding applying external force to a welding area to avoid affecting welding quality.
5) inspecting an appearance of welded magnetic sheet to ensure that the welding area is flat, smooth, and free of cracks or defects; performing a performance test on the welded magnetic sheet, such as tensile testing, magnetic performance testing, etc., to ensure that it meets requirements for use. When non-conforming products appear, a magnetic sheet with non-conforming welding quality should be reworked or scrapped.

The above are only specific embodiments of the present disclosure, but the technical features of the present disclosure are not limited to them.

What is claimed is:

1. A reinforced magnetic sheet, comprising:
two cover plates, which are provided with an inner cavity and the two cover plates are fixedly connected;
a magnet, provided in the inner cavity, one end of the magnet is N pole, and the other end of the magnet is S pole so that the cover plates have magnetic;
wherein the reinforced magnetic sheet further comprises:
a reinforcement member, which is provided in the inner cavity and fixed on inner sides of the cover plates.

2. The reinforced magnetic sheet according to claim 1, wherein each of two cover plates comprises an end face and a connection face,
there is a gap between end faces of the two cover plates;
connection faces of the two cover plates are spliced together, so that the two cover plates are connected in a sealed manner.

3. The reinforced magnetic sheet according to claim 2, wherein the reinforcement member comprises first reinforcement ribs,
the first reinforcement ribs are fixed to the end faces, and the first reinforcement ribs are fixed to the connection faces.

4. The reinforced magnetic sheet according to claim 3, wherein the reinforcement member comprises second reinforcement ribs,
the second reinforcement ribs are fixed to the end faces, and the second reinforcement ribs are fixed to the first reinforcement ribs.

5. The reinforced magnetic sheet according to claim 1, wherein inner sides of the cover plates are provided with first connection columns,
the first connection columns of the two cover plates are inserted into each other;
the inner sides of the cover plates and the first connection columns are provided with third reinforcement ribs.

6. The reinforced magnetic sheet according to claim 5, wherein a connection between the two cover plates is fixed by ultrasonic welding.

7. The reinforced magnetic sheet according to claim 1, wherein the cover plates are provided with a through hole, and a plate body is provided between the two cover plates;
the plate body is provided corresponding to the through hole so that customized information on the plate body is provided in the through hole.

8. The reinforced magnetic sheet according to claim 7, wherein the inner sides of the cover plates are provided with an installation part, and the installation part is fixed to the plate body.

9. The reinforced magnetic sheet according to claim 8, wherein the installation part comprises second connection columns, and the second connection columns of the two cover plates are inserted into each other;
the plate body is provided with an installation hole, and the second connection columns pass through the installation hole;
the inner sides of the cover plates and the second connection columns are provided with fourth reinforcement ribs.

10. The reinforced magnetic sheet according to claim 1, wherein the cover plates are provided with a recess, and the recess is recessed towards a direction of the inner cavity.

11. The reinforced magnetic sheet according to claim 1, wherein the inner sides of the cover plates are provided with an installation frame, and the installation frame is provided with an installation groove,
the installation groove is configured to install the magnet, and an inner side of the installation groove is provided with fifth reinforcement ribs.

12. The reinforced magnetic sheet according to claim 1, wherein the inner sides of the cover plates are provided with a light-emitting element, the cover plates are transparent cover plates, and light from the light-emitting element is capable of passing through the cover plates.

13. The reinforced magnetic sheet according to claim 12, wherein a battery is provided on the inner sides of the cover plates, and the battery supplies power to the light-emitting element.

14. A manufacturing method for the reinforced magnetic sheet according to claim 1, comprising the following steps:
S1: injecting two cover plates into one piece through a mold;
S2: installing a magnet in an inner cavity of the cover plates;
S3: processing a plate body separately, customizing the plate body, and then placing the plate body between the two cover plates;
S4: fixing the two cover plates together by splicing.
